(19) United States
(12) Patent Application Publication
(10) Pub. No.: US 2015/0234989 A1
(43) Pub. Date: Aug. 20, 2015

(54) Patient Transition by Web Based program to have real time availability of Skilled nursing home beds

(71) Applicants: Kamal Kejriwal, Redlands, CA (US); Rajesh Bhageria, Loveland, OH (US)

(72) Inventors: Kamal Kejriwal, Redlands, CA (US); Rajesh Bhageria, Loveland, OH (US)

(21) Appl. No.: 14/108,172

(22) Filed: Feb. 14, 2014

(51) Int. Cl. G06F 19/00

(52) U.S. Cl. CPC G06F 19/327

(57) ABSTRACT

A process that enables hospitals to check on line availability and booking of nursing home beds in the area by creating a database that is updated online/periodically by nursing homes and using web based technology by hospitals.

The process is to have a web based program where all the nursing homes in a particular geographical area will be encouraged to register on the web site. They will be required to update their current nursing home bed availability. The area hospital case managers will also have the access to the website about the available nursing home beds. The hospital discharge planners can have the real time access about the bed availability. In this way patient would get transferred to appropriate facility in an efficient manner where the bed is available. This will free up the hospital bed sooner. The patient can start the skilled nursing home treatment sooner. This program will save resources and has potential to improve care. The program will replace the existing workflow in place where case managers from hospital call each nursing facility in a geographical area to find the nursing home bed available when patient needs these services.

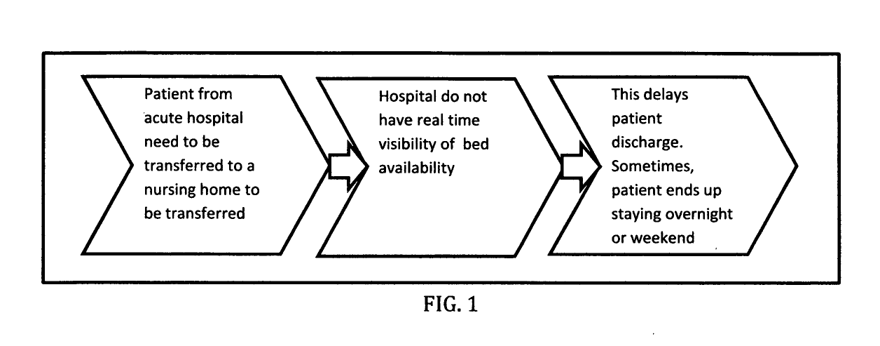

FIG. 1 explains the current process of transferring the patients to nursing home. In the current process, when the patient who needs to be transferred from the hospital to the nursing home, the discharge planners at the hospital will call the listed facilities to find the bed availability. It takes too much of their time and resources. Sometimes, if it is afterhours/weekends, they are unable to reach the appropriate staff. Once they find the available bed in a particular nursing home, patient will be discharged to the facility.

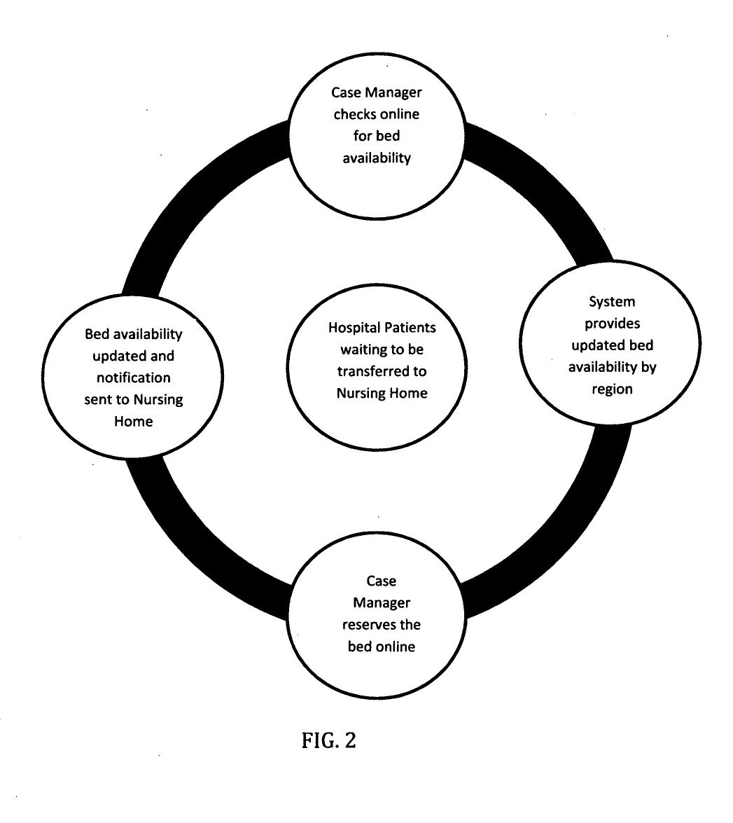

FIG. 2 explains the new process that we are asking for the patent. Once the decision is made to discharge the patient from the hospital, the discharge planners will go on the created website where they will have a real time updates of the nursing home bed availability in the geographical area. They can secure that bed on the secured website. This will help in early and safe transition of patient from hospital to nursing home.

The claims that we are making are:

1. At present there is no web based program which can provide the real time bed availability of skilled and custodial nursing home beds.

2. Expediting the discharge of medically stable patients from hospital to nursing home.

3. for CEO, administrators and Directors of nursing home to know their real time bed inventory for effective use of their resources.
